(19) United States
(12) Patent Application Publication
(10) Pub. No.: US 2021/0123750 A1
(43) Pub. Date: Apr. 29, 2021

(54) AUTONOMOUS VEHICLE AND METHOD FOR PLANNING U-TURN PATH THEREOF

(71) Applicants: Hyundai Motor Company, Seoul (KR); Kia Motors Corporation, Seoul (KR); Korea University Research and Business Foundation, Seoul (KR)

(72) Inventors: Seong Su Im, Anyang (KR); Hyun Kyu Kim, Seoul (KR); Dae Hie Hong, Seoul (KR); Su Young Choi, Seoul (KR)

(21) Appl. No.: 16/997,444

(22) Filed: Aug. 19, 2020

(30) Foreign Application Priority Data
Oct. 29, 2019 (KR) 10-2019-0135558

(51) Int. Cl. G01C 21/34; G01C 21/36

(52) U.S. Cl. CPC G01C 21/3407; G01C 21/3676

(57) ABSTRACT

An autonomous vehicle and a method for generating a U-turn path thereof are provided. In response to detecting a U-turn section ahead of the vehicle based on a travel route mapped to the precise map information stored in a memory, the autonomous vehicle calculates a behavior characteristic of the vehicle while being driven in the U-turn section. The vehicle then generates a U-turn path based on the behavior characteristic of the vehicle.

### CROSS-REFERENCE TO RELATED APPLICATION

This application claims the benefit of priority to Korean Patent Application No. 10-2019-0135558, filed on Oct. 29, 2019, the entire contents of which are incorporated herein by reference.

### TECHNICAL FIELD

The present disclosure relates to an autonomous vehicle and a method for planning a U-turn path thereof.

### BACKGROUND

In general, an autonomous vehicle determines whether a preceding vehicle is present on a traveling path of the autonomous vehicle, and performs a collision prediction determination, based on a travel route. Therefore, the travel route of the autonomous vehicle is generated such that longitudinal and lateral control of the autonomous vehicle may follow the route. If the autonomous vehicle does not follow the travel route generated by a route planning method, the determination of whether there is the preceding vehicle, the collision prediction determination, and the like may not be performed correctly, which may increase a collision risk. Similarly, when the autonomous vehicle performs a U-turn, surrounding vehicles are present, such as a vehicle that performs a U-turn together in front of the autonomous vehicle, a vehicle that turns right at an intersection at the same time, and the like, pedestrians, and the like. Thus, it is important to generate the travel route that the autonomous vehicle may follow well while performing the U-turn. In other words, the travel route should be maintained to avoid collision with risks present just outside the travel route.

A conventional U-turn path planning algorithm generates a U-turn path in a circular arc curve form of a constant turning radius. However, an actual vehicle does not travel with the same turning radius due to an understeer phenomenon during U-turning. In this connection, the understeer phenomenon refers to a phenomenon in which an actual vehicle rotation radius becomes greater than a front wheel steering angle when the vehicle is turning. Path followability and driving stability may be reduced in a U-turn section due to a difference between the actual turning radius of the autonomous vehicle and the turning radius on the travel route generated in the circular arc curve form resulted from such understeer phenomenon.

In addition, the conventional U-turn path planning algorithm generates a path based on a lane link of precise map data. In this connection, the lane link, which is point data indicated at a center of a lane, is used when generating the travel route of the autonomous vehicle. However, the lane link is artificially generated data when generating the precise map data, and thus, a lane link-based route generating method is unable to be used for a section without the lane link.

### SUMMARY

The present disclosure provides an autonomous vehicle that generates a U-turn path based on a U-turn section behavior characteristic (e.g., dynamic characteristic) of the vehicle, and a method for planning the U-turn path thereof.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an autonomous vehicle may include a storage configured to store precise map information, and a processor configured to calculate a behavior characteristic of the vehicle while being driven in the U-turn section in response to detecting a U-turn section ahead of the vehicle based on a travel route mapped to the precise map information, and generate a U-turn path based on the behavior characteristic of the vehicle.

In one exemplary embodiment, the processor may be configured to calculate a tire slip angle based on a wheel steering angle and a vehicle velocity using a tire model when the vehicle is being driven in the U-turn section, and calculate a turning radius variation of the vehicle based on the tire slip angle using a vehicle model. The processor may be configured to divide the U-turn section into a first section, a second section, and a third section based on the turning radius variation. In particular, the first section may be defined as a section where the turning radius increases due to an understeer phenomenon as the vehicle velocity increases. The second section may be defined as a section where the turning radius is constant as the velocity is maintained after reaching a target velocity. The third section may be defined as a section for entering a target lane after the U-turn is completed.

In addition, the processor may be configured to generate a first section U-turn path and a third section U-turn path respectively for the first section and the third section using a clothoid curve. The processor may be configured to generate a second section U-turn path for the second section using a circular arc curve. The processor may be configured to combine the first section U-turn path, the second section U-turn path, and the third section U-turn path to generate the U-turn path. The processor may then be configured to operate the vehicle to perform U-turn along the U-turn path.

According to another aspect of the present disclosure, a method for planning a U-turn path of an autonomous vehicle may include, calculating a behavior characteristic of the vehicle while being driven in the U-turn section in response to detecting a U-turn section ahead of the vehicle based on a travel route mapped to precise map information, and generating a U-turn path based on the behavior characteristic of the vehicle.

In one exemplary embodiment, the calculating of the behavior characteristic of the vehicle may include calculating a tire slip angle based on a wheel steering angle and a vehicle velocity during U-turn using a tire model, and calculating a turning radius variation of the vehicle based on the tire slip angle using a vehicle model. The generating of the U-turn path may include dividing the U-turn section into a first section, a second section, and a third section based on the turning radius variation.

In particular, the first section may be defined as a section where the turning radius increases due to an understeer phenomenon as the vehicle velocity increases. The second section may be defined as a section where the turning radius is constant as the velocity is maintained after reaching a target velocity. The third section may be defined as a section for entering a target lane after U-turn is completed.

In addition, the planning of the U-turn path may include generating a first section U-turn path and a third section U-turn path respectively for the first section and the third section using a clothoid curve. The generating of the U-turn path may include generating a second section U-turn path for the second section using a circular arc curve. In addition, the generating of the U-turn path may include combining the first section U-turn path, the second section U-turn path, and the third section U-turn path to generate the U-turn path. The method may further include, after generating the U-turn path, operating the vehicle to perform the U-turn along the U-turn path.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram of an autonomous vehicle according to an exemplary embodiment of the present disclosure;

FIG. 2 is a view for illustrating a behavior characteristic of a vehicle during turning associated with an exemplary embodiment of the present disclosure;

FIG. 3 is a view for illustrating a change in a turning radius during U-turn associated with an exemplary embodiment of the present disclosure;

FIG. 4 is a diagram for illustrating a slip angle associated with an exemplary embodiment of the present disclosure;

FIG. 5 is a graph showing a relationship between a slip angle and a lateral force associated with an exemplary embodiment of the present disclosure;

FIG. 6 is a view schematizing a bicycle model associated with an exemplary embodiment of the present disclosure;

FIG. 7 is a graph showing a change in a vehicle turning radius based on a slip angle according to an exemplary embodiment of the present disclosure;

FIG. 8 is a view for illustrating a U-turn section classification scheme associated with an exemplary embodiment of the present disclosure;

FIG. 9 illustrates a scheme for generating a route for each section associated with an exemplary embodiment of the present disclosure;

FIG. 10 illustrates a clothoid curve associated with an exemplary embodiment of the present disclosure;

FIG. 11 illustrates a clothoid segment associated with an exemplary embodiment of the present disclosure;

FIG. 12 is a view for illustrating first section U-turn path planning according to an exemplary embodiment of the present disclosure;

FIGS. 13 and 14 are views for illustrating second section U-turn path planning according to an exemplary embodiment of the present disclosure;

FIG. 15 is a view for illustrating third section U-turn path planning according to an exemplary embodiment of the present disclosure;

FIG. 16 illustrates a U-turn path planned according to an exemplary embodiment of the present disclosure;

FIG. 17 is a flowchart illustrating a method for planning a U-turn path of an autonomous vehicle according to an exemplary embodiment of the present disclosure; and

FIGS. 18A and 18B illustrate examples of planning a U-turn path of an autonomous vehicle according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, some exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the exemplary embodiment of the present disclosure, a detailed description of the related known configuration or function will be omitted when it is determined that it interferes with the understanding of the embodiment of the present disclosure.

In describing the components of the exemplary embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present disclosure relates to a technology that generates a travel route in a U-turn section based on a change in a turning radius (e.g., a radius of rotation) of a vehicle due to an understeer phenomenon, which occurs when the vehicle is being driven in the U-turn section, so that an error between an actual travel route of the vehicle and a generated travel route is reduced, thereby improving a travel stability.

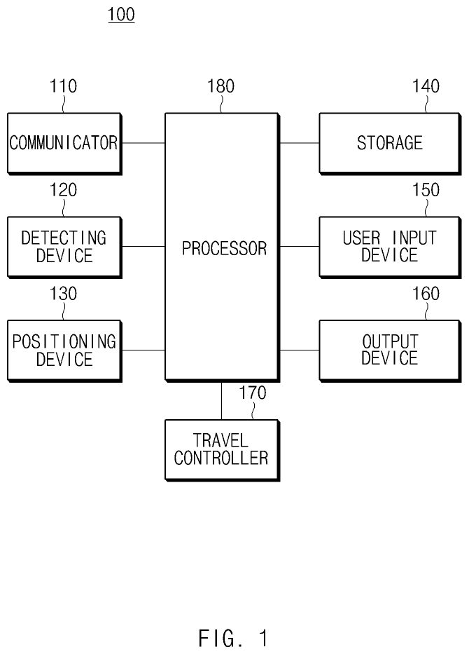

Referring to FIG. 1, an autonomous vehicle (hereinafter, a vehicle) 100 may include a communicator 110, a detecting device 120, a positioning device 130, storage 140, a user input device 150, an output device 160, a travel controller 170, and a processor 180. In particular, the communicator 110 may be configured to perform wired and/or wireless communication. As a wired communication technology, a Local Area Network (LAN), a Wide Area Network (WAN), an Ethernet, and/or an Integrated Services Digital Network (ISDN), and the like may be used.

Further, as a wireless communication technology, a vehicle communication (Vehicle to Everything, V2X), a wireless Internet, and/or a mobile communication may be used. In this connection, a communication between a vehicle and a vehicle (Vehicle to Vehicle, V2V), a communication between a vehicle and an infrastructure (Vehicle to Infrastructure, V2I), a communication between a vehicle and a mobile device (Vehicle-to-Nomadic Devices, V2N), and/or an in-vehicle communication (In-Vehicle Network, IVN), or the like may be applied as the V2X technology. As the wireless communication technology, at least one of communication technologies such as telematics, a wireless LAN (WLAN) (WiFi), a Wireless broadband (Wibro), a World Interoperability for Microwave Access (Wimax), and/or the like may be used. As a mobile communication technology, at least one of communication technologies such as a Code Division Multiple Access (CDMA), a Global System for Mobile communication (GSM), a Long Term Evolution (LTE), an International Mobile Telecommunication (IMT)-2020, and/or the like may be used.

The detecting device 120 may be configured to obtain surrounding environment information and/or vehicle information of the vehicle 100 via sensors mounted on the vehicle 100. The sensors may include a camera (e.g., an image sensor), a Radio Detection and Ranging (RADAR), a Light Detection And Ranging (LiDAR), an ultrasonic sensor, a velocity sensor, a steering angle sensor, an acceleration sensor, and the like. The detecting device 120 may be configured to obtain the vehicle information (e.g., vehicle velocity, vehicle traveling time, and the like) from various electric control units (ECUs) connected via the IVN. The IVN may be implemented as a Controller Area Network (CAN), a Media Oriented Systems Transport (MOST) network, a Local Interconnect Network (LIN), an Ethernet, an X-by-Wire (Flexray), and/or the like.

The positioning device 130 may be configured to measure a current position of the vehicle 100. In particular, the positioning device 130 may be configured to measure a vehicle position using at least one of positioning technologies such as a Global Positioning System (GPS), a Dead Reckoning (DR), a Differential GPS (DGPS), a Carrier Phase Differential GPS (CDGPS), and/or the like. The storage 140 may be configured to store software programmed to allow the processor 180 to perform a predetermined operation, and may be configured to temporarily store input data and/or output data of the processor 180. The storage 140 may also be configured to store software programmed to perform following driving and/or autonomous driving of the vehicle 100. The storage 140 may be implemented as at least one of storage media (recording media) such as a flash memory, a hard disk, an SD card (Secure Digital Card), a random access memory (RAM), a static random access memory (SRAM), a read only memory (ROM), a programmable read only memory (PROM), an electrically erasable and programmable ROM (EEPROM), an erasable and programmable ROM (EPROM), a register, a removable disk, a web storage, and the like.

Additionally, the storage 140 may be configured to store precise map information. The precise map information may be updated automatically at predetermined intervals or manually by a user. The storage 140 may also be configured to store vehicle dimension information. The vehicle dimension information may include at least one of information such as a length, a wheel base, a width, and a vehicle weight (tolerance weight). The storage 140 may be configured to store a slip angle calculation algorithm using a tire model, a vehicle turning radius calculation algorithm using the tire model, a path generation algorithm, and the like.

The user input device 150 may be configured to generate input data based on a user's manipulation. The user input device 150 may be implemented as a keyboard, keypad, a button, a switch, a touch pad, and/or a touch screen, and the like. For example, the user input device 150 may be configured to generate an autonomous driving initiate command based on the user's manipulation.

The output device 160 may be configured to output progress and results based on an operation of the processor 180 in a form of visual, auditory, and/or tactile information. The output device 160 may include a display, an audio output module, a tactile feedback output module, and the like. The display may be implemented as at least one of display device such as a liquid crystal display (LCD), a thin film transistor-liquid crystal display (TFT LCD), an organic light-emitting diode (OLED) display, a flexible display, a 3D display, a transparent display, a head-up display (HUD), a touch screen, a cluster, and the like. The audio output module may be configured to output audio data stored in the storage 140. The audio output module may include a receiver, a speaker, and/or a buzzer, and the like. The tactile feedback output module may be configured to output a signal in a form that the user may perceive with a tactile sense. For example, the tactile feedback output module may be implemented as a vibrator to adjust vibration intensity, pattern, or the like.

The travel controller 170 may be configured to operate the vehicle 100 based on an instruction of the processor 180. Although not shown in the drawing, the travel controller 170 may include a memory configured to store software programmed to allow the travel controller 170 to perform a predetermined operation, a processor configured to execute the software stored in the memory, and the like. The travel controller 170 may be configured to operate a power source controller (e.g., an engine controller) for operating a power source (e.g., an engine and/or a drive motor, or the like) of the vehicle 100, a braking controller, a steering controller, and/or a shift controller to adjust acceleration, deceleration, braking, shifting, and/or steering of the vehicle 100.

The power source controller may be configured to adjust an output of the power source based on accelerator pedal position information or a traveling velocity requested from the processor 180. The braking controller may be configured to adjust a braking pressure based on a position of the brake pedal or based on an instruction from the processor 180. The shift controller configured to operate a transmission of the vehicle 100, may be implemented as an electronic shifter or a shift by wire (SBW). The steering controller, configured to adjust the steering of the vehicle 100, may be implemented as a motor drive power steering (MDPS).

Further, the processor 180 may be configured to execute an overall operation of the vehicle 100. The processor 180 may be implemented as at least one of an application specific integrated circuit (ASIC), a digital signal processor (DSP), a programmable logic device (PLD), field programmable gate arrays (FPGAs), a central processing unit (CPU), microcontrollers, and/or microprocessors. The processor 180 may be configured to generate a travel route based on destination information input from the user input device 150. The processor 180 may also be configured to generate a global route for reaching a destination from the current position (i.e., vehicle position) of the vehicle 100 as the travel route. When the generation of the travel route is completed, the processor 180 may be configured to operate the travel controller 170 to initiate driving along the generated travel route. The processor 180 may be configured to map the travel route on the precise map information stored in the storage 140 and display the travel route on the display.

The processor 180 may further be configured to generate a local path within a predetermined distance (e.g., about 10 km ahead of the vehicle) from the vehicle position based on the travel route while the vehicle 100 is being driven. In the present exemplary embodiment, a scheme for planning a local path for a U-turn section, that is, a U-turn path may be proposed. The processor 180 may be configured to determine whether there is the U-turn section ahead based on the travel route after initiating the traveling. In other words, the processor 180 may be configured to detect the U-turn section located ahead of the vehicle.

When the vehicle 100 reaches the recognized U-turn section and stops, the processor 180 may be configured to obtain environment information and vehicle information via the detecting device 120 and the positioning device 130. For example, the processor 180 may be configured to obtain information such as a lane width, the number of surrounding vehicles, and the like via the camera and the like. In addition, the processor 180 may be configured to calculate a straight-line distance (e.g., horizontal distance) from the current position (i.e., vehicle position) of the vehicle 100 to a center of a target lane. In this connection, the target lane refers to a lane of an opposite road where the vehicle 100 will U-turn to enter. The processor 180 may be configured to calculate the straight-line distance using the vehicle position measured by the positioning device 130 and the precise map information stored in the storage 140.

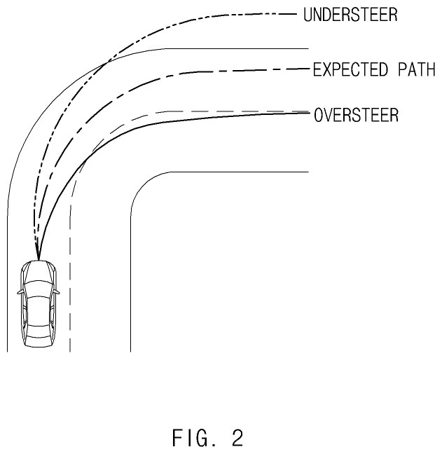

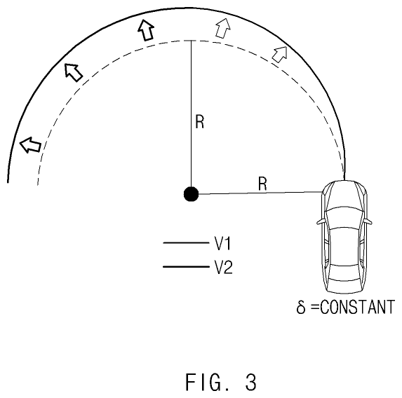

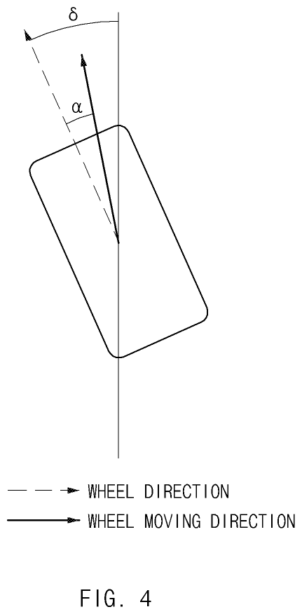

The processor 180 may be configured to plan and generate a U-turn path based on the obtained environment information, vehicle information, and the like to allow the vehicle 100 to be driven along the recognized U-turn section. When planning the U-turn path, the processor 180 may be configured to plan or generate the U-turn path by reflecting a behavior characteristic (e.g., a U-turn section behavior characteristic or a dynamic characteristic) when the vehicle 100 is traveling the U-turn section. As shown in FIG. 2, when the vehicle 100 turns for changing a direction, an understeer phenomenon of increasing a turning radius or an oversteer phenomenon of decreasing the turning radius may occur. Above all, when the understeer phenomenon occurs, as shown in FIG. 3, even when a steering angle δ of the vehicle 100 is constant, a turning radius R changes as the vehicle velocity changes V1→V2. A cause of the understeer phenomenon is a slip angle α occurring at a tire. As shown in FIG. 4, the slip angle refers to an angle between a direction the tire is facing or is directed and an actual traveling direction.

The processor 180 may be configured to generate the U-turn path based on the understeer phenomenon caused by the slip angle. In other words, the processor 180 may be configured to generate the U-turn path by reflecting the U-turn section traveling behavior characteristic (e.g., the U-turn section behavior characteristic) of the vehicle 100 due to the understeer phenomenon. The scheme for planning the U-turn path may be divided into a vehicle dynamics calculation part and a path data generation part.

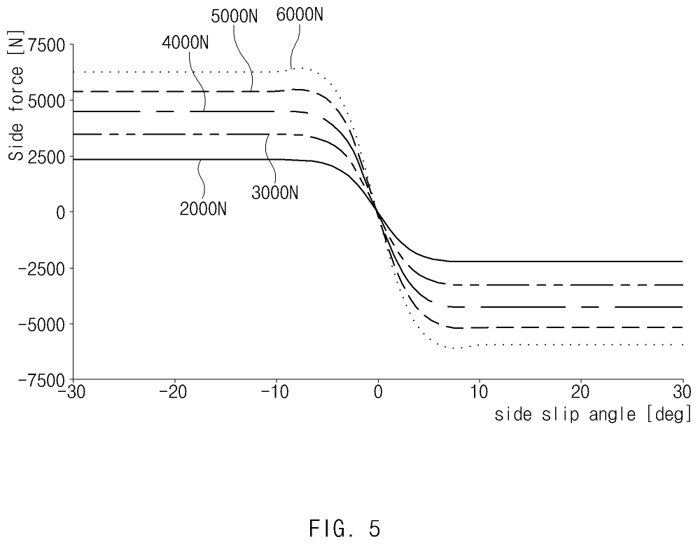

First, the vehicle dynamics calculation part will be described. The processor 180 may be configured to calculate a tire slip angle based on the wheel steering angle δ and the vehicle velocity during the U-turning through tire modeling. In other words, the processor 180 may be configured to generate a tire model that defines a relationship between the slip angle of the tire and a side force (or lateral force) through the tire modeling. In this connection, a magic formula (MF) tire model may be used as the tire model. The processor 180 may be configured to define a relationship between the slip angle and the side force (hereinafter, lateral force) based on a vertical weight applied to the tire using the MF tire model. For example, the processor 180 may be configured to define the lateral force of the tire based on a change in the slip angle as shown in FIG. 5.

The processor 180 may be configured to calculate slip angles occurred at a front tire and a rear tire during the U-turning using the tire model that is a result of the tire modeling. Tire slip angles (i.e., a front wheel slip angle and a rear wheel slip angle) may be calculated through following calculation processes. A relationship between a lateral slip angle αₗ of the tire and a lateral force F_{y} may be defined as in Equation 1.

F_{y}=Cα₁ Equation 1

wherein, C is a cornering stiffness.

Further, the lateral force F_{y} is affected by a vehicle mass (vehicle weight) m and a lateral acceleration a_{y}. Therefore, the lateral force F_{y} may be defined as in Equation 2.

F_{y}=ma_{y} Equation 2

The lateral acceleration a_{y} of Equation 2 may be represented as in Equation 3.

$${a}_{y} = \frac{{V}^{2}}{{R}_{0}} \qquad Equation 3$$

wherein, V is a longitudinal velocity, that is, a vehicle velocity, and R₀ means a turning radius that does not reflect the slip angle (that is, a turning radius when no slip angle occurs).

When Equation 3 is substituted into Equation 2, it may be represented as in Equation 4.

$${F}_{y} = \frac{m {V}^{2}}{{R}_{0}} \qquad Equation 4$$

According to Equation 4, the lateral force may be calculated from the vehicle velocity V and the turning radius R₀ during the U-turning. The slip angle corresponding to the lateral force may be derived from a graph (MF graph) in which the relationship between the slip angle and the lateral force is defined. In other words, the relationship between the slip angle and the lateral force may be generated as the tire model, and used to calculate the slip angle of the tire during the U-turning. Equation 1 and Equation 4 may be organized to represent such tire model as in Equation 5.

$${α}_{1} = \frac{m {V}^{2}}{{CR}_{0}} \qquad Equation 5$$

The processor 180 may be configured to calculate the slip angles that occurred at the front wheel tire and the rear wheel tire during the U-turning using the tire model, respectively. In other words, the processor 180 may be configured to calculate the slip angles of the front wheel and the rear wheel using Equation 5, respectively. The processor 180 may be configured to calculate a vehicle turning radius with respect to the tire slip angle calculated using the tire model. Since the tire slip angle is lateral dynamics of the vehicle, the vehicle 100 may be modeled using a bicycle model that may represent the lateral dynamics.

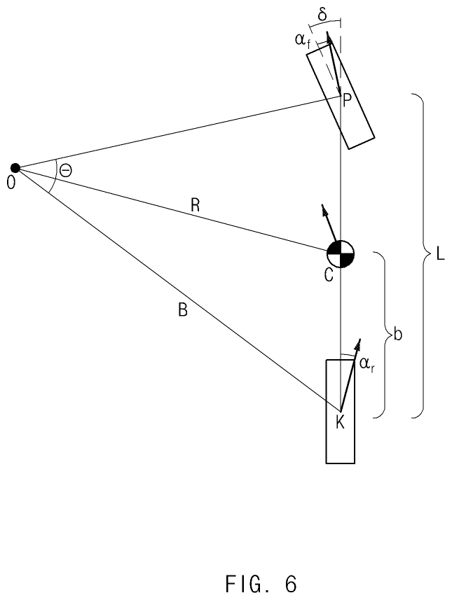

In the bicycle model illustrated in FIG. 6, a relationship between the slip angle and the vehicle turning radius may be organized in a formula. In FIG. 6, an angle Θ(=∠POK) formed by connecting segments of lines respectively passing through a front wheel center and a rear wheel center based on a center of turning O, may be represented as in Equation 6 below.

θ=δ−α_{f}+αᵣ Equation 6

In this connection, δ is a front wheel steering angle (wheel steering angle), αf is a front wheel slip angle, and αr is a rear wheel slip angle. A distance B from the center of turning of the vehicle 100 to the rear wheel center may be defined as in Equation 7 using a sinusoidal formula.

$$B = \frac{cos ( δ - {α}_{f} )}{sin X} E L \qquad Equation 7$$

In this connection, L refers to a wheel base which is a horizontal distance between the front wheel center and the rear wheel center. A straight-line distance from the vehicle position calculated above to a center of the target lane may be used to calculate the steering angle δ of the vehicle required to reach the target lane from a stop position before starting the U-turn. The turning radius R in consideration of the slip angle may be represented as in Equation 8 using a second cosine formula

$$R = \sqrt{{B}^{2} + {b}^{2} - 2 B b cos ( \frac{π}{2} - {α}_{r} )} \qquad Equation 8$$

wherein, b is a distance from a vehicle center of gravity to the rear wheel center.

In other words, the vehicle turning radius R for the front wheel slip angle and the rear wheel slip angle may be calculated using Equation 8. The turning radius R reflecting such slip angle may be determined by the front wheel slip angle α_{f}, the rear wheel slip angle αᵣ, and the front wheel steering angle δ as defined in Equation 9.

R=f(α_{f},αᵣ,δ) Equation 9

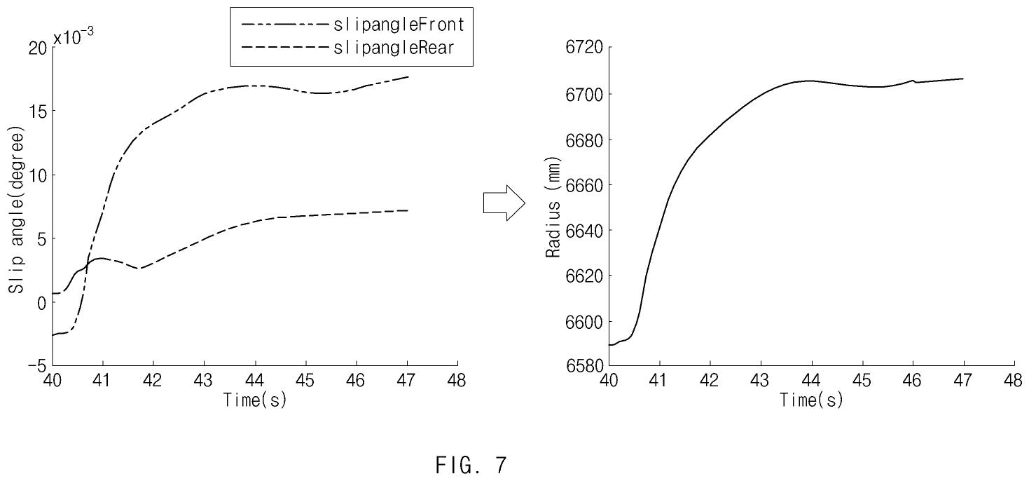

The processor 180 may be configured to calculate the front wheel slip angle α_{f} and the rear wheel slip angle αᵣ during the U-turn using the tire model for the U-turn section, and calculate the change (e.g., variation) in the vehicle tuning radius based on the slip angles α_{f} and αᵣ calculated using the vehicle model. In this connection, it may be assumed that the vehicle 100 rotates while accelerating the vehicle velocity to a target velocity from a stopped state during the U-turn. For example, the processor 180 may be configured to calculate a change in the vehicle turning radius based on a front wheel slip angle (slipangleFront) and a rear wheel slip angle (slipangleRear) as shown in FIG. 7 using the vehicle model. In other words, the processor 180 may be configured to calculate a change in the turning radius (a turning radius variation) for the U-turn section.

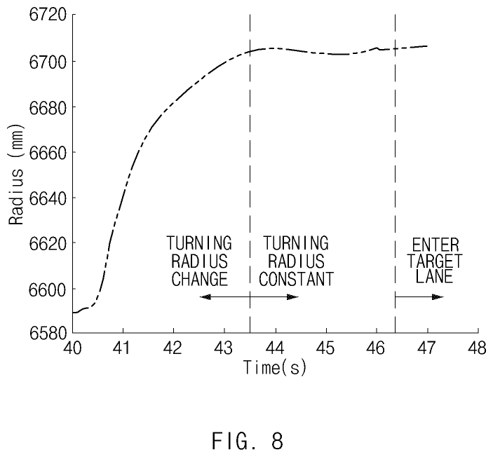

Furthermore, the path data generation part will be described herein below. The processor 180 may be configured to divide the U-turn section into three sections based on the change in the turning radius for the U-turn section. As shown in FIG. 8, the processor 180 may be configured to divide the U-turn section into a turning radius change section (hereinafter, referred to as a first section), a turning radius constant section (hereinafter, referred to as a second section) and a target lane entry section (hereinafter, referred to as a third section). In this connection, the first section is a section in which the turning radius increases due to the understeer phenomenon as the vehicle velocity increases. The second section is a section in which the turning radius is constant as the velocity is reached to the target velocity and maintained. Further, the third section, which is a section for entering the target lane when the U-turn is almost finished, is a section in which the turning radius decreases.

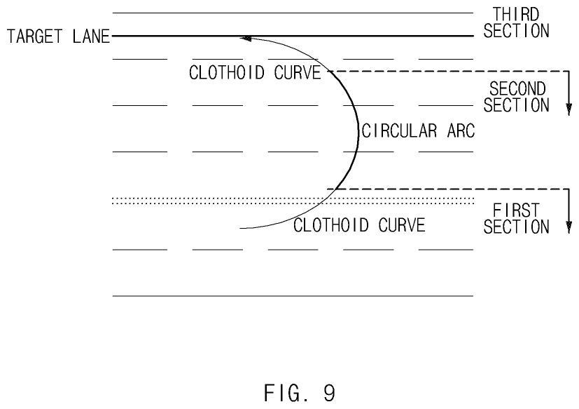

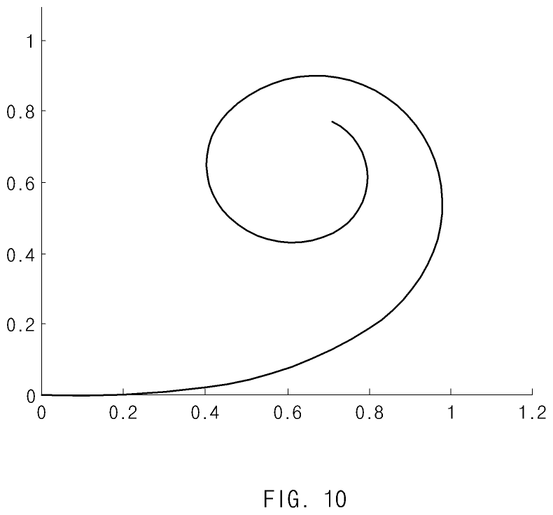

The processor 180 may be configured to generate U-turn paths for the first, second, and third sections using a clothoid curve and a circular arc curve. Referring to FIG. 9, the processor 180 may be configured to generate U-turn paths for the first section and the third section using the clothoid curve, and generate a U-turn path for the second section using the circular arc curve. The clothoid curve is a curve in which the turning radius decreases as a length increases as shown in FIG. 10. The clothoid curve may be defined as in Equation 10 and Equation 11 by a Fresnal integral in which X and Y are represented as parameters.

$$\begin{matrix}X ( t ) = {{@}^{{t}_{1}}}_{{A}_{{t}_{0}}} cos ( {x}^{2} ) dx & Equation 10 \\ Y ( t ) = {{@}^{{t}_{1}}}_{{A}_{{t}_{0}}} sin ( {x}^{2} ) dx & Equation 11\end{matrix}$$

wherein, parameters t₀ and t₁ are variables for setting a range for using only a segment of the clothoid curve.

The clothoid curve may be defined as in Equation 12 by multiplying clothoid coefficients M and N to the Fresnal integral.

$$M {(}_{y ( N t )}^{X ( N t )} ) = \begin{matrix} \\ \end{matrix} \begin{matrix}8 M {{@}^{{t}_{1}}}_{{A}_{{t}_{0}}} cos ( {Nx}^{2} ) dx 9 \\ H M {{@}^{{t}_{1}}}_{{A}_{{t}_{0}}} sin ( {Nx}^{2} ) dx I\end{matrix} \begin{matrix} \\ \end{matrix} \qquad Equation 12$$

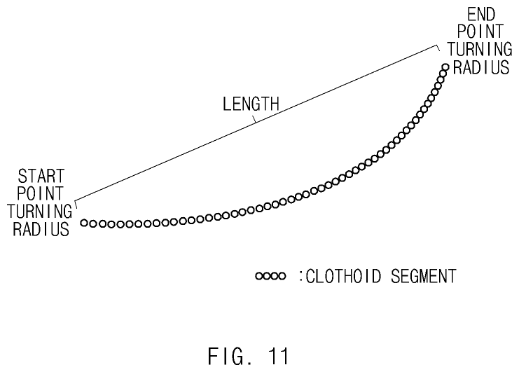

Referring to Equation 12, the coefficients M and N and the parameters t₀ and t₁, that is, four variables, determine a shape of the clothoid curve (that is, the radius of curvature and the length). When a start point turning radius, an end point turning radius, and a length of a clothoid segment shown in FIG. 11 are set, such variables M, N, t₀, and t₁ may be calculated therefrom. In other words, based on the vehicle velocity during the U-turn and a change in the turning radius calculated from a straight-line distance from a U-turn starting position to the target lane, the coefficients M and N, and the parameters t₀ and t₁, which determine the shape of the clothoid curve, may be calculated.

The start point turning radius and the end point turning radius of the clothoid segment may be calculated from the change in the turning radius obtained using the vehicle model. A length of the clothoid segment may be calculated from a velocity profile of the vehicle 100 during the U-turn. The length and turning radius of the clothoid segment, which are the clothoid parameters, may be calculated. In this connection, the length is a curve length of the clothoid segment calculated based on the vehicle velocity, and is M(t₀-t₁). The turning radius is a change in the turning radius of the start point and the end point of the clothoid segment from the change in the turning radius of the vehicle, and is

$$\frac{M}{2 N t} .$$

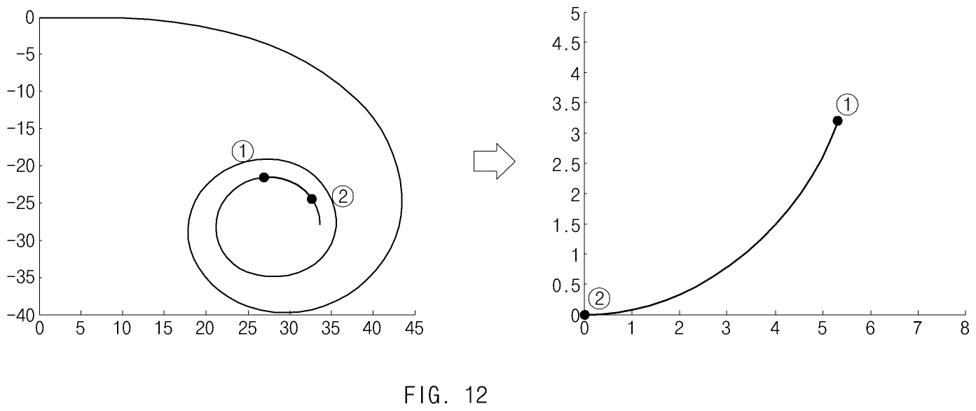

The clothoid curve is generated based on the calculated parameters. To form the path, the clothoid segment may be moved to a vehicle position relative to an absolute coordinate. As shown in FIG. 12, one of both end points of the clothoid segment may be moved to an origin of the absolute coordinate, and the clothoid segment may be rotated based on the origin to generate a clothoid curve path.

For example, in a clothoid curve with M of 6.56 and N of 0.0219, when a turning radius of an end point \textcircled{1} of a clothoid segment with t₀ of 24 and t₁ of 25 is 6.25, and a turning radius of an end point \textcircled{2} of the clothoid segment is 6, as shown in FIG. 12, the end point \textcircled{2} of the clothoid segment is moved to a reference vehicle position on the absolute coordinate.

A method for generating the path for the second section using a circular arc curve will be described. When the velocity and the steering angle of the vehicle 100 are constant, the tire slip angle is constant and the turning radius is also constant. Thus, the path for the second section with the constant turning radius may be generated using the circular arc curve. In other words, the processor 180 may be configured to generate the U-turn path for the second section by applying the circular arc curve.

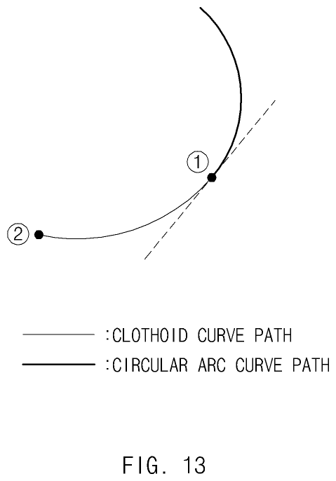

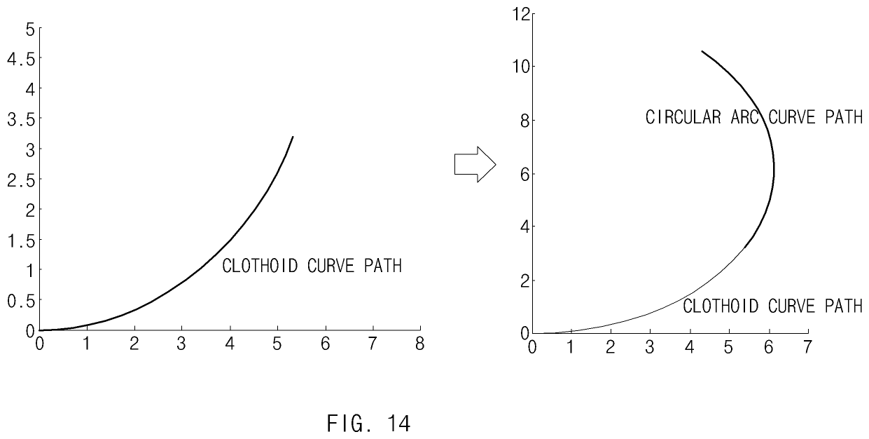

The circular arc curve path for the second section, that is, the second section U-turn path, uses the end point of the first section U-turn path, which is the clothoid curve path, as a start point. In this connection, as shown in FIG. 13, a slope of the start point of the second section U-turn path (circular arc curve path) is the same as a slope of the end point of the first section U-turn path (clothoid curve path). The end point turning radius of the first section U-turn path and a start point turning radius of the second section U-turn path are also the same. When the second section U-turn path is generated, the processor 180 moves a second section U-turn path (i.e., circular arc curve path) generated as shown in FIG. 14, and connects a start point thereof with the end point of the clothoid curve path (i.e., first section U-turn path).

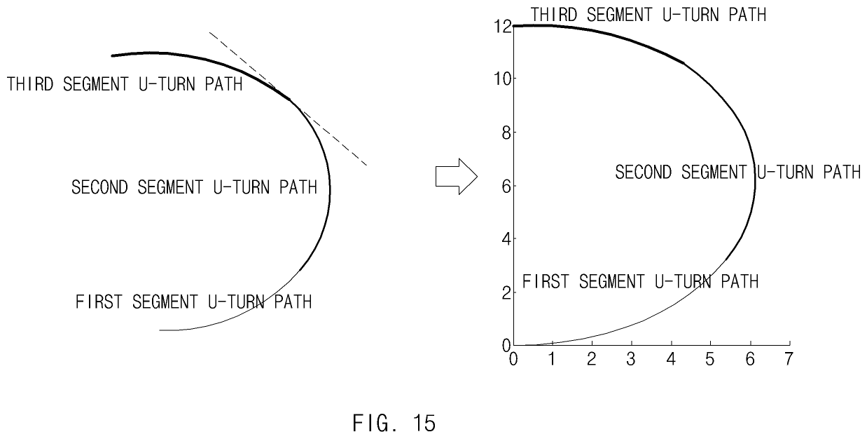

While the vehicle 100 is being driven in the U-turn section, the last section, that is, the third section, is a section for entering the target lane while releasing a steering wheel. Therefore, the path may be generated using the clothoid curve for reflecting a change in a curvature from the circular arc curve path to the target lane. The processor 180 may be configured to generate the U-turn path (clothoid curve path) for the third section using the clothoid curve. Referring to FIG. 15, a start point of the third section U-turn path has the same slope as the end point of the second section U-turn path. The start point of the third section U-turn path may be connected to the end point of the second section U-turn path.

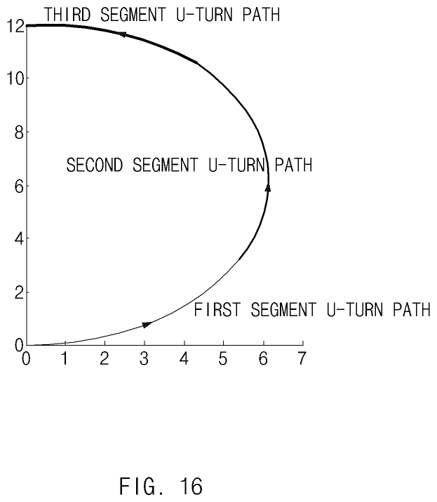

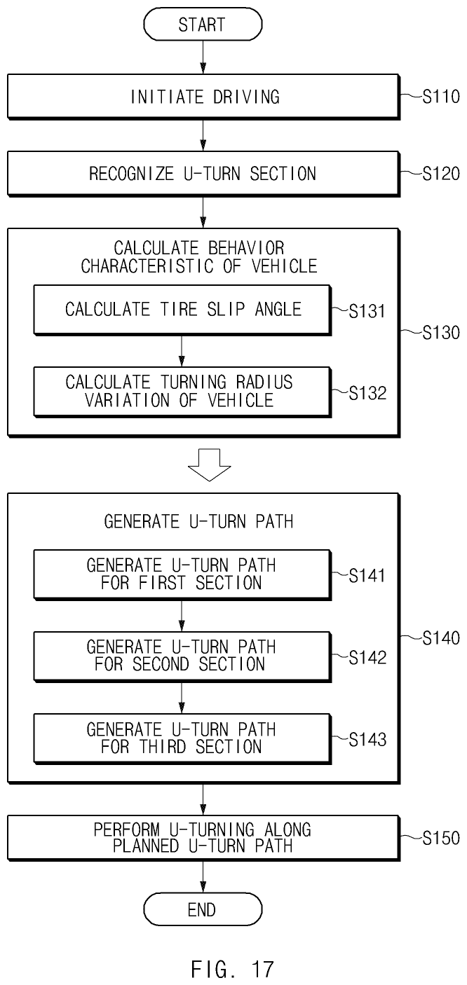

As described above, the processor 180 may be configured to divide the U-turn section into the three sections, and generate the U-turn path for each section using the clothoid curve or the circular arc curve. The processor 180 may be configured to combine the generated U-turn paths of respective sections to plan the U-turn path for the U-turn section as shown in FIG. 16. Further, FIG. 17 is a flowchart illustrating a method for planning a U-turn path of an autonomous vehicle according to one embodiment of the present disclosure.

First, the processor 180 of the vehicle 100 may be configured to operate the travel controller 170 to initiate the driving (e.g., autonomous driving) along the travel route (S110). When the destination is set, the processor 180 may be configured to generate the travel route to the destination, and the vehicle 100 may be driven along the generated travel route. The processor 180 may be configured to detect the U-turn section located ahead of the vehicle 100 on the travel route while the vehicle 100 is being driven (S120). In other words, the processor 180 may be configured to determine whether the U-turn section is present ahead of the vehicle based on the travel route.

When the U-turn section is detected, when the vehicle 100 is being driven in the detected U-turn section, the processor 180 may be configured to calculate the behavior characteristic (e.g., U-turn section behavior characteristic) of the vehicle 100 (S130). After the vehicle 100 reaches the detected U-turn section and stops, the processor 180 may be configured to obtain the surrounding environment information and the vehicle position information using the detecting device 120 and the positioning device 130. The processor 180 may be configured to calculate the straight-line distance from the vehicle position (e.g., U-turn starting position) to the center of the target lane using the vehicle position information and the precise map information. The calculated straight-line distance may be used to calculate the steering angle of the vehicle required to reach the target lane from the stop position before starting the U-turn.

More specifically, the processor 180 may be configured to calculate the tire slip angle using the tire model (S131). The processor 180 may be configured to the front wheel slip angle and the rear wheel slip angle of the vehicle 100 while the vehicle is being driven in the U-turn section. The processor 180 may also be configured to calculate the front wheel slip angle and the rear wheel slip angle based on the velocity profile of the vehicle 100 while the vehicle is being driven in the U-turn section. The processor 180 may be configured to reflect the front wheel slip angle and the rear wheel slip angle calculated in the vehicle model to calculate the change in the turning radius of the vehicle 100 for the U-turn section (S132). In addition, the processor 180 may be configured to calculate the change in the vehicle turning radius for the front wheel slip angle and the rear wheel slip angle calculated using the vehicle model.

The processor 180 may then be configured to generate the U-turn path based on the calculated change in the turning radius (S140). The processor 180 may be configured to divide the U-turn section into the first section, the second section, and the third section to generate the U-turn path for each section. The processor 180 may be configured to divide the U-turn section into three sections by distinguishing the section in which the turning radius changes (e.g., the section in which the turning radius increases and the section in which the turning radius decreases) and the section in which the turning radius is constant, based on the turning radius change for the U-turn section.

In particular, the processor 180 may be configured to generate the U-turn path for the first section using the clothoid curve (S141). In this connection, the first section is the section in which the turning radius increases as the vehicle velocity increases to the target velocity. The processor 180 may be configured to generate the U-turn path for the second section using the circular arc curve (S142). The second section is the section with the constant turning radius. The processor 180 may be configured to generate the U-turn path for the third section using the clothoid curve (S143). The third section is the section in which the turning radius decreases to enter the target lane after the U-turn. Then, the processor 180 may be configured to combine the U-turn paths of the first section, the second section, and the third section to generate one U-turn path. The processor 180 may be configured to execute the U-turning of the vehicle 100 along the planned U-turn path (S150). Particularly, the processor 180 may be configured to operate the travel controller 170 to allow the vehicle 100 to travel along the planned U-turn path.

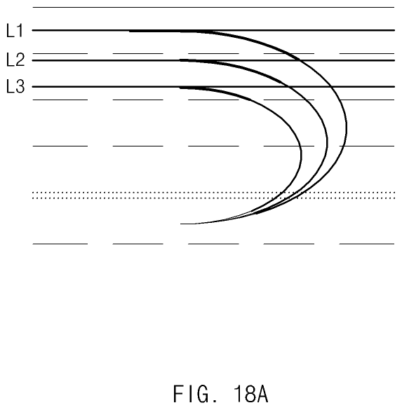

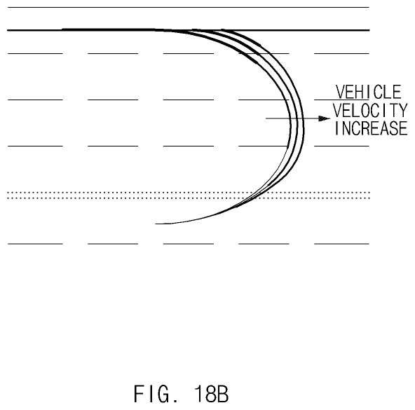

Further, FIGS. 18A and 18B illustrate examples of planning or generating a U-turn path of an autonomous vehicle according to one exemplary embodiment of the present disclosure. Referring to FIG. 18A, as straight-line distances from the vehicle position to target lanes L1, L2, and L3, which is to be entered after the U-turn, increases, a steering angle of the vehicle 100 increases, thereby generating a U-turn path with increasing turning radius. Referring to FIG. 18B, when a target lane to be entered after the U-turn is the same but the vehicle velocity increases, a turning radius of a U-turn path for a corresponding U-turn section increases.

In the above exemplary embodiments, the U-turn path may be generated based on the change in the turning radius due to the understeer phenomenon, but the present disclosure is not limited thereto. The U-turn path may be generated based on the change in the turning radius due to the oversteer phenomenon.

The description above is merely illustrative of the technical idea of the present disclosure, and various modifications and changes may be made by those skilled in the art without departing from the essential characteristics of the present disclosure. Therefore, the exemplary embodiments disclosed in the present disclosure are not intended to limit the technical idea of the present disclosure but to illustrate the present disclosure, and the scope of the technical idea of the present disclosure is not limited by the exemplary embodiments. The scope of the present disclosure should be construed as being covered by the scope of the appended claims, and all technical ideas falling within the scope of the claims should be construed as being included in the scope of the present disclosure.

According to the present disclosure, since the U-turn path may be generated based on the U-turn section behavior characteristic of the vehicle, the path followability in the U-turn section may be improved. Therefore, accuracies of determination of in-path targets (e.g., preceding vehicles and the like) and the collision prediction calculated based on the path to be traveled by the autonomous vehicle may be increased, thereby enabling safer autonomous driving.

Further, according to the present disclosure, since the U-turn path may be generated based on the change in the turning radius during the traveling of the U-turn section, a path error may be reduced during the U-turn section traveling of the autonomous vehicle. In addition, according to the present disclosure, since the U-turn path may be generated based on the U-turn section behavior characteristic of the vehicle, the U-turn path may be planned even in a section without the lane link.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An autonomous vehicle, comprising:
a storage configured to store precise map information; and
a processor configured to, calculate a behavior characteristic of the vehicle while the vehicle is being driven in a U-turn section in response to detecting the U-turn section ahead of the vehicle based on a travel route mapped to the precise map information, and generate a U-turn path based on the behavior characteristic of the vehicle.

2. The autonomous vehicle of claim 1, wherein the processor is configured to:
calculate a tire slip angle based on a wheel steering angle and a vehicle velocity when the vehicle is being driven in the U-turn section using a tire model; and
calculate a turning radius variation of the vehicle based on the tire slip angle using a vehicle model.

3. The autonomous vehicle of claim 2, wherein the processor is configured to divide the U-turn section into a first section, a second section, and a third section based on the turning radius variation.

4. The autonomous vehicle of claim 3, wherein the first section is defined as a section where the turning radius increases due to an understeer phenomenon as the vehicle velocity increases.

5. The autonomous vehicle of claim 3, wherein the second section is defined as a section where the turning radius is constant as the velocity is maintained after reaching a target velocity.

6. The autonomous vehicle of claim 3, wherein the third section is defined as a section for entering a target lane after U-turn is completed.

7. The autonomous vehicle of claim 3, wherein the processor is configured to generate a first section U-turn path and a third section U-turn path respectively for the first section and the third section using a clothoid curve.

8. The autonomous vehicle of claim 7, wherein the processor is configured to generate a second section U-turn path for the second section using a circular arc curve.

9. The autonomous vehicle of claim 8, wherein the processor is configured to combine the first section U-turn path, the second section U-turn path, and the third section U-turn path to generate the U-turn path.

10. The autonomous vehicle of claim 9, wherein the processor is configured to operate the vehicle to perform U-turn along the U-turn path.

11. A method for planning a U-turn path of an autonomous vehicle, comprising:
calculating, by a processor, a behavior characteristic of the vehicle while being driven in a U-turn section, in response to detecting the U-turn section ahead of the vehicle based on a travel route mapped to precise map information; and
generating, by the processor, a U-turn path based on the behavior characteristic of the vehicle.

12. The method of claim 11, wherein the calculating of the behavior characteristic of the vehicle includes:
calculating, by the processor, a tire slip angle based on a wheel steering angle and a vehicle velocity during a U-turn using a tire model; and
calculating, by the processor, a turning radius variation of the vehicle based on the tire slip angle using a vehicle model.

13. The method of claim 12, wherein the generating of the U-turn path includes:
dividing, by the processor, the U-turn section into a first section, a second section, and a third section based on the turning radius variation.

14. The method of claim 13, wherein the first section is defined as a section where the turning radius increases due to an understeer phenomenon as the vehicle velocity increases.

15. The method of claim 13, wherein the second section is defined as a section where the turning radius is constant as the velocity is maintained after reaching a target velocity.

16. The method of claim 13, wherein the third section is defined as a section for entering a target lane after U-turn is completed.

17. The method of claim 13, wherein the generating of the U-turn path includes:
generating, by the processor, a first section U-turn path and a third section U-turn path respectively for the first section and the third section using a clothoid curve.

18. The method of claim 17, wherein the generating of the U-turn path includes:
generating, by the processor, a second section U-turn path for the second section using a circular arc curve.

19. The method of claim 18, wherein the generating of the U-turn path includes:
combining, by the processor, the first section U-turn path, the second section U-turn path, and the third section U-turn path to generate the U-turn path.

20. The method of claim 19, further comprising, after the generating of the U-turn path:
operating, by the processor, the vehicle to perform the U-turn along the U-turn path.
